(19) United States
(12) Patent Application Publication
(10) Pub. No.: US 2025/0189741 A1
(43) Pub. Date: Jun. 12, 2025

(54) OPTICAL FIBER CABLES AND SYSTEM ARCHITECTURES FOR FLEXIBLE DEPLOYMENT IN RURAL SETTINGS

(71) Applicant: CORNING RESEARCH & DEVELOPMENT CORPORATION, Corning, NY (US)

(72) Inventor: Joseph Clinton Jensen, Lawndale, NC (US)

(21) Appl. No.: 19/052,831

(22) Filed: Feb. 13, 2025

Related U.S. Application Data
(63) Continuation of application No. PCT/US2023/030430, filed on Aug. 17, 2023.
(60) Provisional application No. 63/399,808, filed on Aug. 22, 2022.

(51) Int. Cl. G02B 6/44; G02B 6/245; G02B 6/255

(52) U.S. Cl. CPC G02B 6/443; G02B 6/245; G02B 6/255; G02B 6/441; G02B 6/4434

(57) ABSTRACT

Embodiments of the disclosure relate to a fiber distribution system. The fiber distribution system includes an optical fiber cable with a cable jacket having an inner surface, an outer surface, and an opening extending through the inner surface and the outer surface. Optical fibers are disposed within the central bore, and optical fibers include a first optical fiber that extends from the central bore through the opening of the cable jacket. An optical splitter is disposed outside of the optical fiber cable, and the first optical fiber is optically coupled to a first end of the optical splitter. At least two optical fibers are optically coupled to a second end of the optical splitter. An overmold surrounds the opening of the cable jacket and the optical splitter.

### CROSS-REFERENCE TO RELATED APPLICATIONS

This application is a Continuation of International Application No. PCT/US2023/030430, filed Aug. 17, 2023, which claims the benefit of priority of U.S. Provisional Application Ser. No. 63/399,808 filed on Aug. 22, 2022, the content of which is relied upon and incorporated herein by reference in its entirety.

### BACKGROUND

The disclosure relates generally to optical fiber networks and, in particular, to optical fiber cables and architectures for distributing optical fiber signals over large distances, such as in rural settings. Pre-terminated fiber distribution systems having been deployed in optical networks throughout the country, particularly in urban and suburban areas. In these settings, the density of subscribers is sufficient such that the subscribers can be fed from a single location. Indeed, in such settings the runs of cables are typically only in the range of 3000 feet to 5000 feet. However, in rural settings, this is not the case. Subscribers have a very low density, and runs of cable are much longer. As such, it is no longer practical to feed subscribers from a single location. Further, in rural settings, the availability of labor as well as the associated material and placement costs make deployment of passive optical networks more difficult than in urban and suburban settings.

### SUMMARY

According to an aspect, embodiments of the disclosure relate to a fiber distribution system. The fiber distribution system including an optical fiber cable. The optical fiber cable includes a cable jacket having an inner surface, an outer surface, and an opening extending through the inner surface and the outer surface. The inner surface defines a central bore extending along a longitudinal axis of the optical fiber cable, and the outer surface defines an outermost surface of the optical fiber cable. A plurality of optical fibers is disposed within the central bore, and the plurality of optical fibers includes a first optical fiber that extends from the central bore through the opening of the cable jacket. An optical splitter is disposed outside of the optical fiber cable, and the first optical fiber is optically coupled to a first end of the optical splitter. The optical splitter is configured to split the optical signal of the first optical fiber into at least two components. At least two optical fibers are optically coupled to a second end of the optical splitter, and each optical fiber of the at least two optical fibers is configured to carry a component of the at least two components. An overmold surrounds the opening of the cable jacket and the optical splitter.

According to another aspect, embodiments of the disclosure relate to a fiber distribution system. The fiber distribution system includes an optical fiber cable. The optical fiber cable includes a main subunit having a plurality of optical fibers. The plurality of optical fibers extend through an opening in the main subunit. A plurality of auxiliary subunits are stranded together with the main subunit along a longitudinal axis of the optical fiber cable. Each auxiliary subunit contains an auxiliary optical fiber having an upstream side and a downstream side. An overmold surrounds the opening of the main subunit. A first half of the plurality of optical fibers are optically coupled to the upstream sides of the auxiliary optical fibers, and a second half of the plurality of optical fibers are coupled to the downstream sides of the auxiliary optical fibers. Each auxiliary subunit drops off from the main subunit at a location upstream of the overmold and at a location downstream of the overmold.

According to still another aspect, embodiments of the disclosure relate to a fiber distribution system. The fiber distribution system includes a first distributed tap terminal having a terminal input with a first number of terminal input ports and a terminal output with a second number of terminal output ports. The second number is greater than the first number. The first distributed tap terminal is configured to divide optical signals from the terminal input ports of the terminal input among the terminal output ports of the terminal output. The first number of terminal input ports including a first optical input port, and the second number of terminal output ports including a first output port and a plurality of other output ports. The fiber distribution system also includes a first optical fiber cable optically coupled to the terminal output. The first optical fiber cable includes a main subunit having a first end and a second end. The main subunit includes at least one optical fiber coupled to the first output port at the first end of the main subunit. The first optical fiber cable also includes a plurality of auxiliary subunits. Each auxiliary subunit of the plurality of auxiliary subunits includes an auxiliary optical fiber, and each auxiliary optical fiber is coupled to an other output port of the plurality of other output ports. A first connector is optically coupled to the second end of the main subunit, and the first connector is configured to make a third number of optical connections with the third number being equal to the first number. The plurality of auxiliary subunits drop from main subunit at respective points along a length of the main subunit between the first end and the second end.

Additional features and advantages will be set forth in the detailed description that follows, and, in part, will be readily apparent to those skilled in the art from the description or recognized by practicing the embodiments as described in the written description and claims hereof, as well as the appended drawings.

It is to be understood that both the foregoing general description and the following detailed description are merely exemplary and are intended to provide an overview or framework to understand the nature and character of the claims.

### BRIEF DESCRIPTION OF THE DRAWINGS

The accompanying drawings are included to provide a further understanding and are incorporated in and constitute a part of this specification. The drawings illustrate one or more embodiment(s), and together with the description serve to explain principles and the operation of the various embodiments.

FIG. 1 depicts a schematic representation of a preconnectorized fiber distribution system, according to an exemplary embodiment;

FIG. 2 depicts a schematic representation of an access point of a fiber optic cable having an optical splitter embedded in an overmold, according to an exemplary embodiment;

FIG. 3 depicts a cross-sectional view of an optical fiber cable including a bundle of one or two fiber subunits, according to an exemplary embodiment;

FIG. 4 depicts a schematic side view of the optical fiber cable of FIG. 3, according to an exemplary embodiment;

FIG. 5 depicts an optical fiber cable having a main subunit and multiple auxiliary subunits, according to an exemplary embodiment;

FIG. 6 depicts the optical fiber cable of FIG. 5 extending from a centralized split past twelve homes on a route, according to an exemplary embodiment;

FIG. 7 depicts the optical fiber cable of FIG. 5 with a central access point, including two local tether cables, and five tether cables formed from the subunits upstream of the access point and five tether cables formed form the subunits downstream of the access point, according to an exemplary embodiment;

FIG. 8 depicts an optical fiber cable in a distributed split network having an access point with a local tether cable and multiple drop cables along its length, according to an exemplary embodiment;

FIGS. 9A and 9B depict optical fiber cables that can be used in the architecture shown in FIG. 8, according to exemplary embodiments;

FIG. 10 depicts an indexed connection between optical fiber cables in the architecture, according to an exemplary embodiment;

FIG. 11 depicts an architecture using four input fibers with a distributed tap, according to an exemplary embodiment;

FIG. 12 depicts an optical fiber cable that can be used with the architecture of FIG. 11, according to an exemplary embodiment;

FIG. 13 depicts a detailed view of the distributed tap architecture of FIG. 11, according to an exemplary embodiment;

FIG. 14 depicts a branched connector for use in the distributed tap architecture of FIG. 11, according to an exemplary embodiment; and

FIG. 15 depicts a branched connector with tap for use in the distributed tap architecture of FIG. 11, according to an exemplary embodiment.

### DETAILED DESCRIPTION

Referring generally to the figures and the following discussion, various embodiments of architectures for deploying preconnectorized optical fiber cables are provided. Advantageously, the disclosed architectures and cables provide flexible and modular deployment schemes for delivering service to customers in low density areas, such as in rural settings. In low density areas, it may be beneficial to split an optical fiber signal over distance instead of at a single location, such as a fiber distribution hub. Moreover, by using preconnectorized solutions and plug-and-play architecture, the connections do not need to be installed and tested in the field, and much of the complexity in forming the connections between fibers and cables can be addressed in the factory. Exemplary embodiments of the architectures and associated cables will be described in greater detail below and in relation to the figures provided herewith, and these exemplary embodiments are provided by way of illustration, and not by way of limitation.

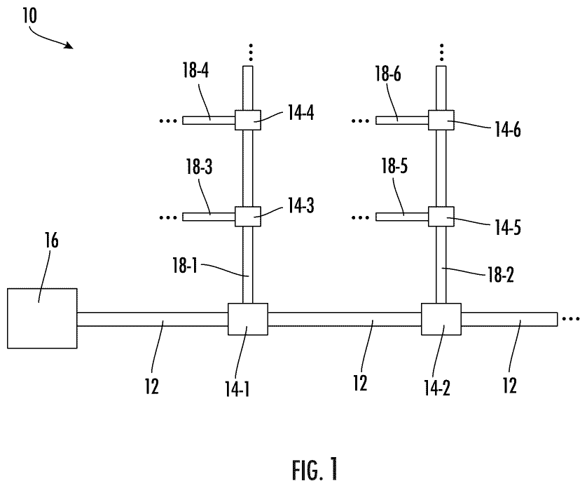

FIG. 1 depicts a schematic representation of an embodiment of a preconnectorized fiber distribution system (PFDS) 10 having an optical fiber cable 12 including a plurality of access points 14. In one or more embodiments, the optical fiber cable 12 is a distribution cable including a plurality of optical fibers. In one or more embodiments, the optical fibers are arranged in one or more subunits, such as buffer tubes. Further, in one or more embodiments, the optical fibers are in a loose tube configuration within the subunits, and in one or more other embodiments, the optical fibers are organized into ribbons within the subunits. In embodiments, the optical fiber cable 12 contains several tens, hundreds, or even thousands of optical fibers.

In the embodiment of the PFDS 10 depicted, the optical fiber cable 12 originates from a central office 16. The optical fiber cable 12 extends along a network path, and at each access point 14 of the PFDS 10, one or more optical fibers from the optical fiber cable 12 are split into one or more tether cables 18. According to embodiments of the present disclosure, the one or more optical fibers are split from the optical fiber cable 12 using an optical splitter embedded into the structure of the optical fiber cable 12. In one or more embodiments, the optical splitter may be a 1:2, 1:4, 1:8, 1:16, or a 1:32 optical splitter.

FIG. 1 depicts an example embodiment of a PFDS 10 for the purpose of illustration. The optical fiber cable 12 extends from the central office 16, and at a first access point 14-1, a 1:4 splitter divides the optical signal of a first optical fiber into four optical fibers carried in a first tether cable 18-1. The remaining optical fibers in the optical fiber cable 12 continue until the second access point 14-2 is reached. At the second access point 14-2, a 1:8 splitter divides the optical signal of a second optical fiber into eight optical fibers of a second tether cable 18-2.

As shown in FIG. 1, the optical signal carried in the optical fibers of the tether cables 18 can be further divided. In the embodiment depicted, the first tether cable 18-1 has a third access point 14-3 in which the optical signal of one of the optical fibers of the first tether cable 18-1 is divided into eight optical fibers of a third tether cable 18-3 using a 1:8 optical splitter. In this way, each optical fiber of the third tether cable 18-3 receives 1/32 of the optical power of the optical signal on the first optical fiber of the optical fiber cable 12, which is generally the most that a signal can be split.

In the example embodiment depicted, the remaining optical fibers in the first tether cable 18-1 continue until the first tether cable 18-1 reaches a fourth access point 14-4 where one of the optical fibers is divided into four optical fibers of a fourth tether cable 18-4 using a 1:4 splitter. Each of the optical fibers in the fourth tether cable 18-4 thus has 1/16 of the optical power of the optical signal on the first optical fiber of the optical fiber cable 12. As such, each optical fiber of the fourth tether cable 18-4 could be split using a 1:2 splitter at a further downstream access point.

Similarly, as shown in the example embodiment of FIG. 1, the second tether cable 18-2 has a fifth access point 14-5 in which the optical signal of one of the optical fibers of the second tether cable 18-2 is divided into four optical fibers of a fifth tether cable 18-5 using a 1:4 optical splitter. In this way, each optical fiber of the fifth tether cable 18-5 receives 1/32 of the optical power of the optical signal on the second optical fiber of the optical fiber cable 12.

Further, in the example embodiment depicted, the remaining optical fibers in the second tether cable 18-2 continue until the second tether cable 18-2 reaches a sixth access point 14-6 where one of the optical fibers is divided into four optical fibers of a sixth tether cable 18-6 using a 1:4 splitter. Each of the optical fibers in the sixth tether cable 18-6 thus has 1/32 of the optical power of the optical signal on the second optical fiber of the optical fiber cable 12.

The optical fiber cable 12, the first tether cable 18-1, the second tether cable 18-2, and any other tether cables would continue through the PDFS 10 until each optical fiber reaches a terminal, such as a home. Further, while the distribution cable 12 and tether cables 18 are depicted as being continuous cables extending directly from the access points 14, the components of the system may actually be discrete cables joined with optical connectors. For example, the first tether cable 18-1 may have a male/female connector that connects to a comparatively short length of cable extending from the access point 14-1 that has a corresponding female/male connector. Similarly, the third and fourth tether cables 18-3, 18-4 may be connectorized and connected to corresponding connectors on short lengths of cables extending from the third and fourth access points 14-4, 14-3. The second, fifth, and sixth tether cables 18-2, 18-5, 18-6 and respective second, fifth, and sixth access points 14-2, 14-5, 14-6 may be constructed in the same manner. In this way, long lengths of cables can be manufactured and connected together in the field to build out the PDFS 10.

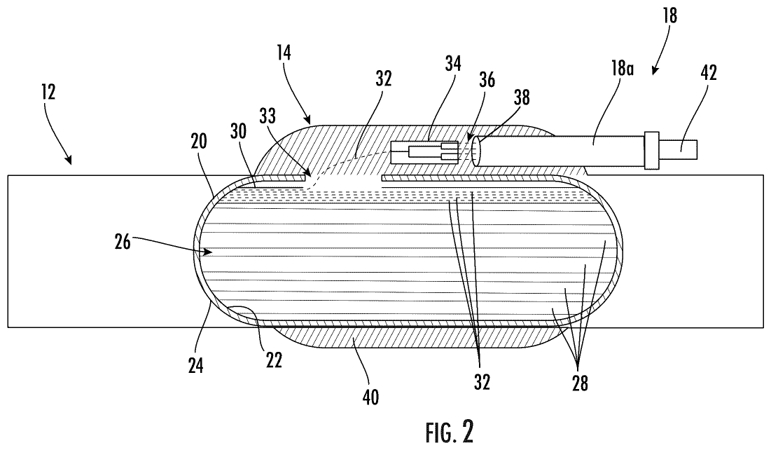

FIG. 2 depicts a detailed, partial cross-sectional, schematic view of an access point 14 of the optical fiber cable 12. In one or more embodiments, the optical fiber cable 12 includes a cable jacket 20 having an inner surface 22 and an outer surface 24. The inner surface 22 defines a central bore 26 extending along a longitudinal axis of the optical fiber cable 12. The outer surface 24 defines an outermost surface of the optical fiber cable 12. In one or more embodiments, the optical fiber cable 12 includes a plurality of subunits 28. In one or more embodiments, including the embodiment depicted in FIG. 2, the subunits 28 include a buffer tube 30 surrounding a plurality of optical fibers 32. At least one of the optical fibers 32 of a subunit 28 is extracted from the buffer tube 30, extends out of an opening 33 in the cable jacket 20, and is coupled to a first end of an optical splitter 34. In the embodiment shown in FIG. 2, the optical splitter 34 is a 1:4 optical splitter that divides the optical power of an optical signal four ways. Four tether fibers 36 are coupled to a second end of the optical splitter 34. The tether fibers 36 are contained in a tether jacket 38 to form at least a portion of the tether cable 18.

In order to access the optical fiber 32, the buffer tube 30 and the cable jacket 20 are opened, potentially exposing interior of the subunit 28 and the optical fiber cable 12 to the environment. In order to protect the interior cable components, the access point 14 is covered with an overmold 40. In one or more embodiments, the overmold 14 comprises a polyurethane material to bond to and encapsulate the cable jacket 20 and tether jacket 38. According to embodiments of the present disclosure, the optical splitter 34 is also contained within overmold 40.

In one or more embodiments, the tether cable 18 includes a first portion 18a that is terminated with a connector 42. In the embodiment shown in FIG. 2, the connector 42 is a male connector, but in other embodiments, the connector 42 may be a female connector. A second portion of the tether 18 that extends downstream into the PFDS 10 can be connected to the first portion 18a of the tether 18. In this way, the single optical fiber 32 separated from one subunit 28 of the optical fiber cable 12 is divided into four tether fibers 36 by the optical splitter 34, which terminate in the connector 42, and the second portion of the tether 18 is optically coupled to the connector 42 to extend the four tether fibers 36 into the PFDS 10, which as discussed above can cach be further split at access points 40 of the tether cable 18.

The embodiment shown in FIG. 2 shows all four downstream fibers fed by the optical splitter 34 being included into a tether cable 18. However, in one or more other embodiments, at least one and up to all of the optical fibers downstream of the optical splitter 34 may be fed back into the optical fiber cable 12. For example, one or more of the optical fibers 36 on the downstream side of the splitter 34 may be an optical fiber from one of the other subunits 28 in the optical fiber cable 12. In this way, for example, a tether cable 18 can be dropped at the access point 14 with one optical fiber 36 being split off to service one (or more) subscriber. The other three optical fibers 36 spliced into the subunit 28 can be accessed downstream to service other subscribers.

By embedding the optical splitter 34 into the overmold 40, the PDFS 10 can be deployed more easily in rural settings. In a rural setting, the homes and businesses served by the optical network have far less density than in urban and suburban settings. As such, the distances of the cable run are much greater, and the availability of installers to deploy and test splitter equipment (such as fiber distribution hubs, optical splice enclosures, and hardened optical terminals) is greatly diminished. Because the optical splitters 34 are embedded into the overmold 40 at each access point 14, the splitters 34 can be installed and tested in the factory, and the preterminated connectors 42 allow for connections to downstream tethers 18 to be more easily be made by installers without the need for splice equipment. The cable 12 is particularly useful for servicing, e.g., 30-50 homes over a long distance path, such as homes positioned serially and adjacent to a long stretch of highway.

According to further embodiments of the present disclosure, a PDFS 10 can be facilitated with a cable containing a bundle of one or two fiber cables as shown in FIG. 3. In one or more embodiments, the optical fiber cable 100 is comprised of a bundle of subunits 102. In one or more embodiments, each subunit 102 of the bundle includes one or two optical fibers 104. In one or more embodiments, the bundle of subunits 102 includes four, eight, sixteen, or thirty-two subunits 102. In one or more embodiments, the subunits 102 are stranded around a central strength member 106, which can help to provide the right starting diameter for the number and layers of subunits 102 to be included in the bundle.

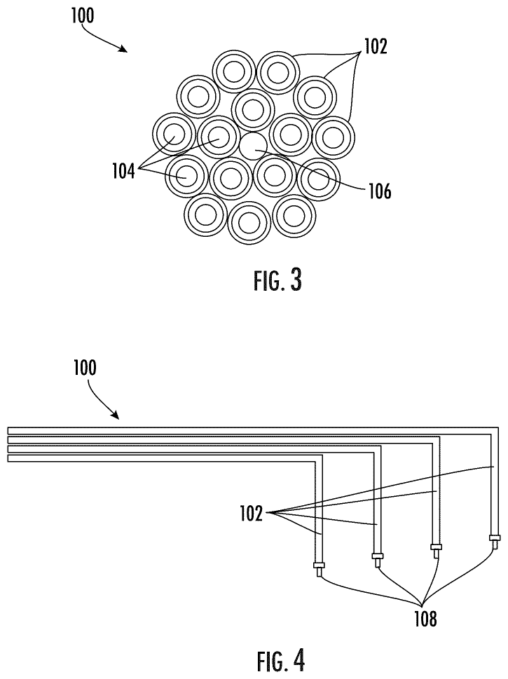

FIG. 4 depicts a schematic side view of an optical fiber cable 100 according to the construction shown in FIG. 3. As can be seen in FIG. 4, the subunits 102 drop from the bundle of the optical fiber cable 100 along the length of the optical fiber cable 100 at various points. When preparing the bundle, the length of each subunit 102 can be selected such that the subunit 102 terminates at the desired location within the PDFS 10. In one or more embodiments, each subunit 102 is preconnectorized with a hardened connector 108 (such as OptiTap® and OptiTip® connectors available from Corning Incorporated, Corning, NY).

Advantageously, the one or two fiber access points along the length of the PDFS 10 provide a low cost and low risk connection without having to access the interior of any cable in the PDFS 10. Additionally, if design errors occur in positioning of the drop points when preparing the optical fiber cable 100 in the factory, the errors can be easily addressed in the field during installation by pulling back the subunit 102 if it is too long or by attaching an extender if the subunit 102 is too short. Further, especially in a rural setting, one fiber subunits 102 can be directly connected to one fiber drop cables to feed single homes without the need for a terminal, thereby lowering the cost and complexity of the PDFS 10.

In one or more embodiments, the length of each subunit 102 in the bundle is the same, and the subunits 102 do not include connectors 108. In such embodiments, the subunits 102 can be cut and connectorized in the field to provide for greater flexibility in the installation process. That is, installers can selectively terminate the subunits 102 as needed in the field. In this and in the previously discussed embodiment, the optical fibers 104 are advantageously isolated from cach other. As such, there is less risk to the other optical fibers 104 when accessing one of the optical fibers 104 at a desired drop point.

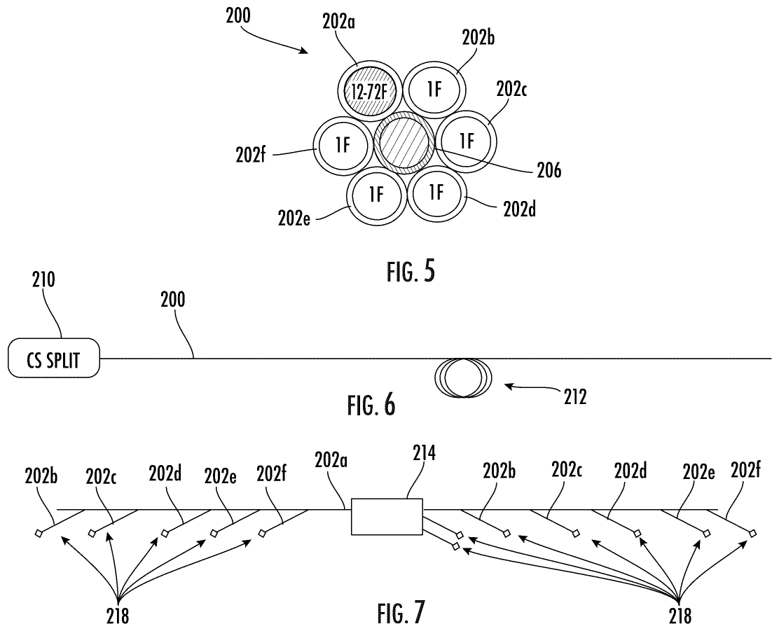

FIGS. 5-15 depict various embodiments of PDFS architectures and associated optical fiber cables designed to accommodate the longer cable runs within the architecture as well as providing low fiber counts with desired accessibility.

FIG. 5 depicts a cross-sectional view of an optical fiber cable 200 configured for providing a mid-span accessible centralized split PDFS architecture. As can be seen in FIG. 5, the optical fiber cable 200 includes a plurality of subunits 202. In one or more embodiments, the optical fiber cable 200 includes a main subunit 202a that includes a plurality of optical fibers, such as twelve to seventy-two optical fibers (12F-72F) or more as needed, and five auxiliary subunits 202b-f that include, e.g., one optical fiber (1F) to four optical fibers. The subunits 202a-f are stranded around a central strength member 206. The main subunit 202a is configured to carry the optical signals, and the auxiliary subunits 202b-f do not carry any optical signal until spliced into the main subunit 202a as will be discussed below. The embodiment of the optical fiber cable 200 shown in FIG. 5 is a bundled optical fiber cable that does not have an outer jacket around the subunits 202a-f. However, in one or more other embodiments, the optical fiber cable 200 can instead be an optical fiber cable as shown in FIG. 2, having a cable jacket defining a bore that carries the subunits 202a-f (which may be buffer tubes carrying one or a plurality of optical fibers). In such an embodiment, the optical fiber cable would have a factory-or field-installed access point at each drop location.

As shown in FIG. 6, the optical fiber cable 200 originates at a centralized split (CS split) 210. For an optical fiber 200 according to the depicted embodiment having a multiple of twelve optical fibers in the main subunit 202a, the optical fiber cable 200 passes twelve subscribers, and slack coils 212 are stored at a central location or at one or more locations along the run of the optical fiber cable 200. As shown in FIG. 7, the main subunit 202a includes an access point 214 at which the auxiliary subunits 202b-f are spliced into the main subunit 202a. Also, as shown in FIG. 7, embodiments of the optical fiber cable 200 can include additional tether cables 218 spliced into the main subunit 202a at the access point 214. The access point 214 is substantially similar to what is described above in relation to FIGS. 1 and 2 except that there is no optical splitter between the optical fibers of the main subunit 202a and the optical fibers of the auxiliary subunits 202b-f or the tether fibers of the additional tether cables 218.

That is, the optical fibers of the main subunit 202a are accessed and a first set of the optical fibers of the main subunit 202a are optically coupled (e.g., spliced) to a downstream side of the optical fibers of the auxiliary subunits 202b-f and a second set of the optical fibers of the main subunit 202a are optically coupled (e.g., spliced) to an upstream side of the optical fibers of the auxiliary subunits 202b-f. In one or more embodiments, the main subunit 202a may have additional optical fibers that can be optically coupled (e.g., spliced) to one or more tether fibers of any additional tether cables 218. An overmold material is provided around the access point to protect it from the environment. Advantageously, the coupling and overmolding can be performed in a factory setting, providing improved optical performance and reducing labor in the field. Notwithstanding, the subunits 202a-f can also or instead be accessed and coupled in the field as needed.

In the embodiment depicted, the five auxiliary subunits 202b-f extend along at least a portion of the length of the optical fiber cable 200. At various points along the optical fiber cable 200, the auxiliary subunits 202b-f drop off the main subunit 202a to provide tether cables 218 from the main subunit 202a leading to individual subscribers. In this way, five tether cables 218 can be provided upstream of the access point 214, and five tether cables 218 can be provided downstream of the access point 214. In one or more embodiments, the auxiliary subunits 202b-f are connectorized at both the upstream ends and the downstream ends of the auxiliary subunits 202b-f (schematically shown using squares at the end of the auxiliary subunits 202b-f in FIG. 7). A main subunit 202a having a multiple of twelve optical fibers will have two additional optical fibers, which can be used for two tether cables 218 locally positioned at the access point 214 as shown in FIG. 7. As such, the optical fiber cable 200 with the main subunit 202a and the auxiliary subunits 202b-f can provide a single fiber for twelve subscribers. In instances where the auxiliary subunits 202b-f contain more than one optical fiber, the additional optical fibers can be spare optical fibers, can provide for future expansion of the optical network, or can provide service to multiple, closely-spaced subscribers if two or more optical fibers of the respective auxiliary subunit 202b-f are spliced into the main subunit 202a.

If the main subunit 202a includes more than twelve optical fibers, then the main subunit 202a may be configured to contain another access point 214 at a location corresponding to a central region between an additional twelve subscribers. The main subunit 202a can then include another five tether cables 218 formed from the five subunits 202b-f upstream of the second access point 214 and five tether cables 218 formed from the five subunits 202b-f downstream of the second access point and two local tether cables 218 spliced into the main subunit 202a at the access point 214. In this way, using the five auxiliary subunits 202b-f and two additional tether cables 218 spliced into the main subunit 202a at an access point, the main subunit 202a can flexibly drop twelve fibers for subscribers located at various distances apart. In one or more embodiments, cach of the tether cables 218 is terminated in an optical connector. Advantageously, such connectors can be incorporated into the cable 200 during manufacture, providing improved optical performance and reducing labor in the field. Notwithstanding, the subunits 202a -f can also or instead be terminated with hardened field installable connectors in the field as needed.

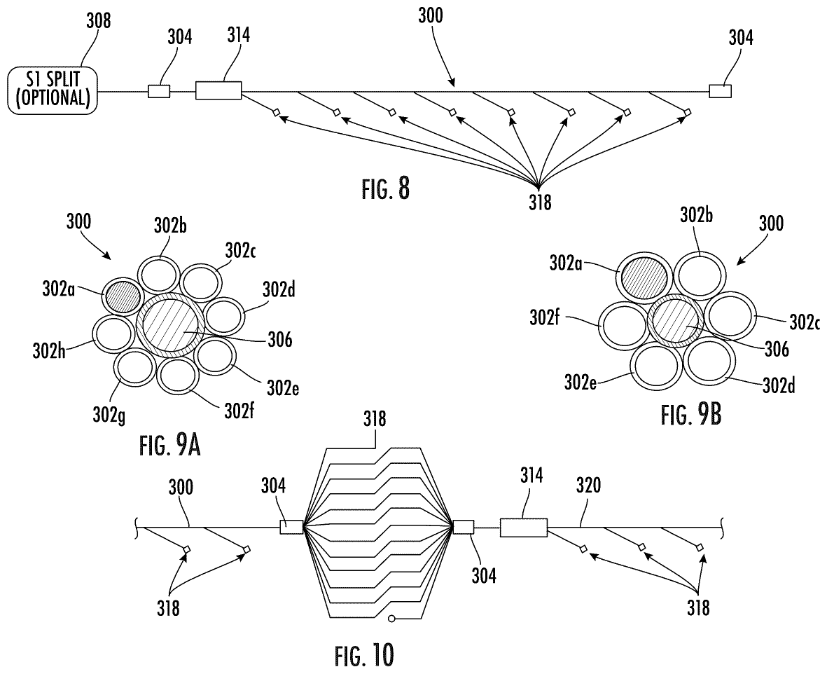

FIG. 8 depicts another PFDS architecture based on a centralized split or distributed split (S1 split) architecture. As shown in FIG. 8, the architecture is a distributed split with an optical fiber cable 300 originating at a first split 308. The first split 308 may be, for example, a 1:4 splitter. The cable entering the first split 308 may include, for example, twelve optical fibers, and each of the twelve optical fibers is split four ways, such that the 1:4 splitter feeds four twelve-fiber optical cables, including optical fiber cable 300. In the embodiment depicted, the optical fiber cable 300 is optically coupled to the first split 308 with a twelve-fiber connector 304. Downstream of the connector 304 is an access point 314 as described above with respect to FIGS. 1 and 2. In particular, the optical fiber cable 300 includes an embedded optical splitter, for example, a 1:8 optical splitter. A first fiber of the optical fiber cable 300 is coupled to the 1:8 optical splitter to provide optical signals for eight tether cables 318. One tether cable 318 drops at the access point 314, and seven additional tether cables 318 drop along the length of the optical fiber cable 300 at various points as needed to connect subscribers.

FIGS. 9A and 9B depict example embodiments of optical fiber cables 300 that can be used in the architecture of FIG. 8. In FIG. 9A, the optical fiber cable 300 includes a main subunit 302a and seven auxiliary subunits 302b-h stranded around a central strength member 306. The main subunit 302a carries the eleven optical fibers that are not coupled to the splitter at the access point 314. With respect to the eight optical fibers connected to the downstream end of the optical splitter, one optical fiber is dropped in a tether cable 318 locally at the access point 314, and the remaining seven optical fibers are carried in the auxiliary subunits 302b-h (the auxiliary subunits 302b-h being connected to the splitter within the access point 314). These subunits 302b-h can be dropped as tether cables 318 at various downstream points. In FIG. 9B, the optical fiber cable 300 includes a main subunit 302a and five auxiliary subunits 302b-f stranded around a central strength member 306. In such an embodiment, the main subunit 302a would again carry the eleven non-split optical fibers. With respect to the eight split optical fibers, three would be in tethers 318 that drop locally at the access point 314, and five would be carried in the auxiliary subunits 302b-f that drop as tether cables 318 at various downstream points. The embodiment of the optical fiber cables 300 shown in FIGS. 9A and 9B are bundled optical fiber cables that do not have outer jackets around the subunits 302a -h and subunits 302a -f. However, in one or more other embodiments, the optical fiber cables 300 can instead each be an optical fiber cable as shown in FIG. 2, having a cable jacket defining a bore that carries the subunits 302a -h, 302a -f (which may be buffer tubes carrying one or a plurality of optical fibers). In such an embodiment, the optical fiber cable would have a factory-or field-installed access point at each drop location.

After the eight tether cables 318 drop off of the optical fiber cable 300, the optical fiber cable 300 terminates in another connector 304. The eleven remaining optical fibers in the optical fiber cable are optically coupled to the connector 304. As shown in FIG. 10, the optical fiber cable 300 is connected to a second optical fiber cable 320 using an indexed connection in which the second optical fiber of the first optical fiber cable 300 is connected to the first optical fiber of the second optical fiber cable 320. By indexing the optical fibers, the first optical fiber cable 300 and the second optical fiber cable 320 can have the same construction. In this way, a plurality of optical fiber cables 300 can be constructed in the factory and chained together in the field. In one or more embodiments, the modular nature of the optical fiber cables 300 is enhanced by sizing the tethers 318 to drop from the optical fiber cable 300 at regular intervals along the length. In such embodiments, the tether cables 318 may be preconnectorized such that extension cables can be connected to the tether cables 318 to provide additional cable length as needed.

In one or more embodiments, the optical fiber cable 300 described in relation to FIGS. 8-10 may not utilize fiber splitting, and instead, the optical fibers may be spliced directly into tether cables 318 without splitting them as described in relation to FIGS. 1 and 2.

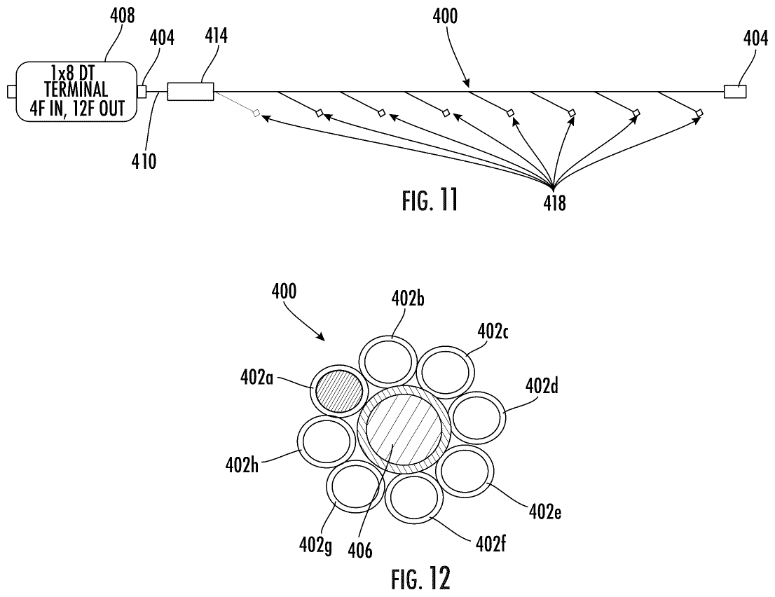

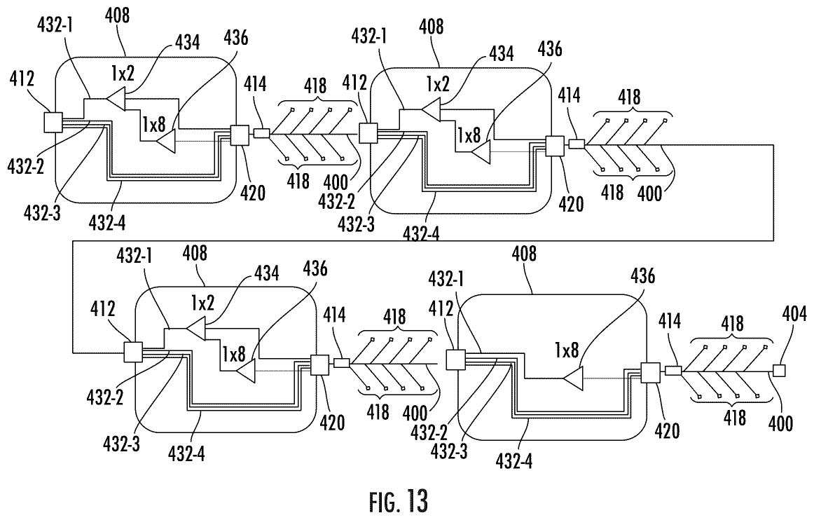

FIG. 11 depicts another PFDS architecture based on distributed taps and indexing features to manage fiber polarity. As shown in FIG. 11, the example architecture includes an optical fiber cable 400 extending from a 1x8 distributed tap terminal 408. The distributed tap terminal 408 has four input optical fibers and provides an output of twelve optical fibers carried by the optical fiber cable 400. A first connector 404 is plugged into he distributed tap terminal 408 and is connected to a twelve-fiber optical fiber cable 410. The twelve-fiber optical fiber cable 410 is joined to an optical fiber cable 400 at access point 414. Referring to FIG. 12, the optical fiber cable 400 includes a main subunit 402a carrying four optical fibers and seven auxiliary subunits 402b-h cach carrying one optical fiber. In one or more embodiments, the main subunit 402a and the auxiliary subunits 402b-h are stranded around a central strength member 406. With reference to FIGS. 11 and 12, the main subunit 402a may be spliced to four optical fibers of the twelve-fiber optical fiber cable 410 at the access point 414, and the auxiliary subunits 402b-h and tether cable 418 may be spliced to the remaining eight optical fibers of the twelve-fiber optical fiber cable 410. Thus, the optical fiber cable 400 includes an access point 414 at which four optical fibers are carried in the main subunit 402a, seven optical fibers are carried in the single fiber auxiliary subunits 402b-h, and one tether cable 418 is dropped at the access point 414. The seven auxiliary subunits 402b-h drop as tether cables 418 or connect to tether cables 418 along the length of the optical fiber cable 400. The main subunit 402a terminates in a four-fiber connector 404 for connection to a downstream optical fiber cable.

The embodiment of the optical fiber cables 400 shown in FIG. 12 is a bundled optical fiber cable that does not have an outer jacket around the subunits 402a -h. However, in one or more other embodiments, the optical fiber cable 400 can instead be an optical fiber cable as shown in FIG. 2, having a cable jacket defining a bore that carries the subunits 402a -h (which may be buffer tubes carrying one or a plurality of optical fibers). In such an embodiment, the optical fiber cable would have a factory-or field-installed access point at each drop location.

FIG. 13 provides a detailed view of the architecture shown in FIG. 11. As can be seen in FIG. 13, the first distributed tap terminal 408 receives four optical fibers at input ports 1 to 4 of the terminal input 412. Off the four optical fibers, three optical fibers 432-2, 432-3, 432-4 are passed through the distributed tap terminal 408 without dividing the signal to output ports 2-4 of the terminal output 420. A first optical fiber 432-1 is divided at a tap 434, which divides the signal into two components. In one or more embodiments, the tap 434 may be a 90/10 tap, 80/20 tap, 70/30 tap, or 60/40 tap, or another discrete step. As an example, a 70/30 tap 434 will divide the single into a first component having 70% of the optical power and a second component having 30% of the optical power. The first 70% component is passed through to the first output port (1) of the terminal output 420. Thus, output ports 1-4 correspond to 70% of the first optical fiber 432-1 and the full signal of optical fibers 432-2, 432-3, 432-4. The second 30% component of the first optical fiber 432-1 is divided at a 1:8 splitter 436 into eight optical fibers that pass to output ports 5-12 of the terminal output 420. For simplicity of illustration, only one line is shown exiting the 1×8 splitter, but this line corresponds to the optical fibers in output ports 5-12 of the distributed tap terminal 408.

As mentioned, the four optical fibers 432-1 to 432-4 carried in output ports 1-4 of the terminal output 420 are ultimately carried in the main subunit 402a along the length of the optical fiber cable 400 (a connectorized twelve-fiber cable may be disposed between the terminal output 420 and the access point 414). One optical fiber from output ports 5-12 is dropped as a tether cable 418 at the access point 414, and the remaining seven optical fibers are carried in auxiliary subunits 402b-h that drop off as or connect to tether cables 418 along the length of the optical fiber cable 400.

The optical fiber cable 400 terminates at a four-fiber connector 404 (as shown in FIG. 11) with optical fibers 432-1 to 432-4 of the main subunit 402a connected to the connector 404. The connector 404 plugs into another distributed tap terminal 408 with the optical fibers 432-1 to 432-4 plugging into input ports 1-4 of the terminal input 412 of the distributed tap terminal 408. As described in relation to the previous terminal, optical fibers 432-2 to 432-4 are passed through to output ports 2-4 of the terminal output, the first optical fiber 432-1 is divided at a tap 434, e.g., a 70/30 tap, which divides the signal into two components. In the example embodiment, the optical fiber 342-1 is already carrying 70% of the original optical signal from the first distributed tap terminal 408, and after passing through the tap 434 of the second distributed tap terminal 408, the first component is 70% *70% or 49% of the original signal and the second component is 70% *30% or 21% of the original signal. The first component is passed through to the first output port (1) of the terminal output 420 such that the first four output ports 1-4 correspond to the 49% component of optical fiber 432-1 and optical fibers 432-2 to 432-4. The second component (21%) of the first optical fiber 432-1 is divided at a 1:8 splitter 436 into eight optical fibers that pass to output ports 5-12 of the output terminal 420.

The four optical fibers 432-1 to 432-4 carried in positions 1-4 of the terminal output are carried in the main subunit 402a of a second optical fiber cable 400. Again, one optical fiber from output ports 5-12 is dropped as a tether cable 418 at the access point 414, and the remaining seven optical fibers are carried in auxiliary subunits 402b-h that drop off as or connect to tether cables 418 along the length of the second optical fiber cable 400.

The first optical fiber 432-1 of the main subunit 402a can pass through another distributed tap terminal 408 in this fashion, which will diminish the original signal to a first component of 70% *70%*70% or 34% and a second component of 70% *70%*30% or 15%. The second component of the first optical fiber 432-1 is divided at a 1:8 splitter 436. The first component is passed through to the first output port (1) of the terminal output 420 such that the first four output ports 1-4 correspond to the 34% component of optical fiber 432-1 and optical fibers 432-2 to 432-4. The eight optical fibers from the splitter 436 pass to output ports 5-12 of the output terminal. The optical signals from the four optical fibers 432-1 to 432-4 carried in output ports 1-4 of the terminal output 420 are carried in the main subunit 402a of a third optical fiber cable 400 to a four- fiber connector 404. Again, one optical fiber from output port 5-12 is dropped as a tether cable 418 at the access point 414, and the optical signals of the remaining seven optical fibers are carried in auxiliary subunits 402b-h that drop off as or connect to tether cables 418 along the length of the third optical fiber cable 400.

The optical signal on the first optical fiber 432-1 can only be divided one further time. Thus, the connector 404 from the third optical fiber cable 400 plugs into a terminal input 420 of a terminal 408 with a 1:8 splitter 436. In particular, the first optical fiber 432-1 plugs into the first input port (1) on the terminal input 412 of the terminal 408, and optical fibers 432-2 to 432-4 plug into input ports 2-4 of the terminal input 412. The optical fibers 432-2 to 432-4 are indexed to output ports 1-3 on the terminal output 420, and the first optical fiber 432-1 is divided by the splitter 436 into eight optical fibers that are again indexed to output ports 5-12 of the terminal output 420. In this way, there is no optical fiber indexed to the fourth output port (4) of the terminal output 420. Optical fibers 432-2 to 432-4 are carried in the main subunit 402a of a fourth optical fiber cable 400 to a four-fiber connector 404, wherein the three optical fibers 432-2 to 432-4 are in positions 1-3 of the connector 404.

From the foregoing, it can be seen that the chain of optical fiber cables 400 utilizes the signal from one optical fiber 432-1 to deliver service to 32 subscribes that can be stretched over a large distance. The three optical fibers 432-2 to 432-4 are not divided, and using the indexing at the last terminal 408, each of the next three optical fibers 432-2 to 432-4 can be divided into thirty-two separate signals as described above, in particular using the same modular equipment. That is, by dividing the optical signal of the optical fiber entering the first input port of the distributed tap terminals and using the indexing of subsequent optical fibers to the first input port, subsequent optical fibers (optical fiber 432-2, followed by 432-3, followed by 432-4) can be divided in series of four optical fiber cables 400 as described above. In this way, four optical fibers can serve 128 subscribers over a large distance, such as in a rural setting, without the need for the expensive of installing and testing such equipment as fiber distribution hubs, optical splice enclosures, and hardened optical terminals.

While the foregoing discussion considered 70/30 taps in each of the distributed tap terminals 408, the terminals could use different divider taps. For example, the taps in successive terminals 408 may be stepped from 90/10 to 80/20 to 70/30 or in another sequence of discrete steps. Further, while the construction considered a four fiber input and twelve fiber output for the terminals, other configurations in which the number of terminal inputs is different from the number of terminal outputs are also possible.

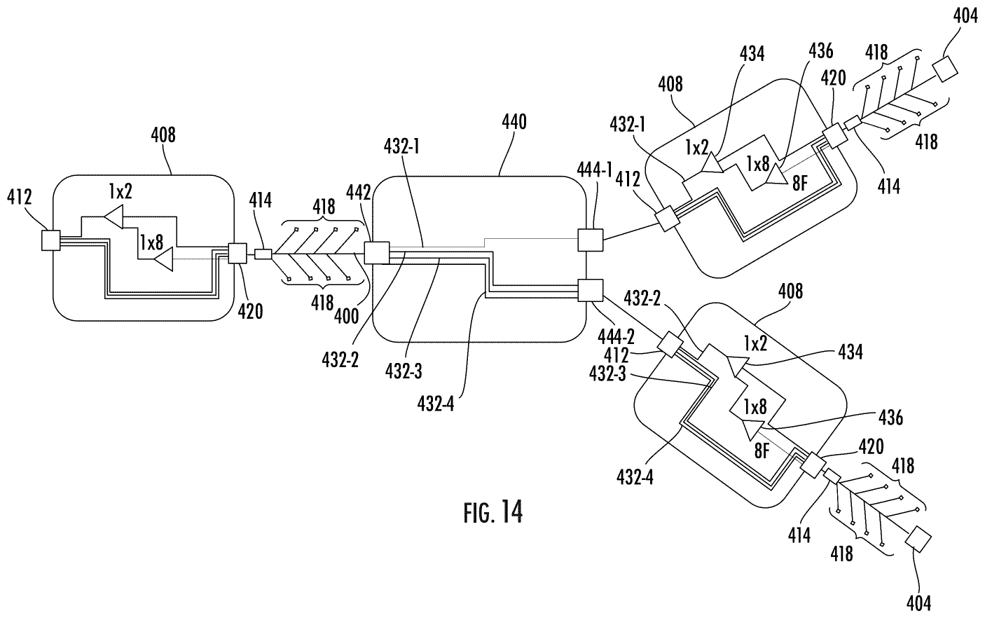

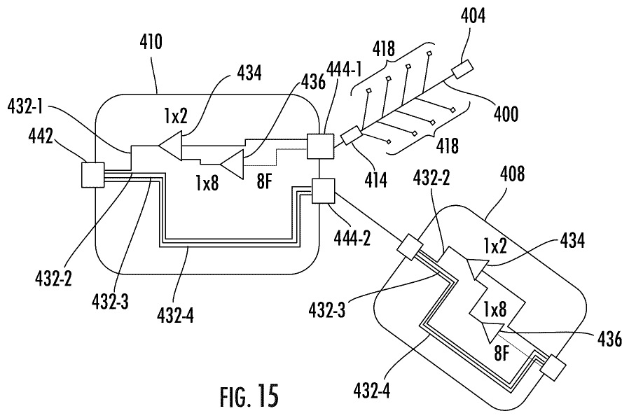

FIGS. 11 and 13 related to a substantially linear deployment of the PFDS, but the architecture can also be made to branch as shown in FIGS. 14 and 15. FIG. 14 depicts a first generalized schematic view of a PFDS architecture including a branched terminal 440. As can be seen in FIG. 14, an optical fiber cable 400 extends from a first distributed tap terminal 408 to the branch terminal 440. In the example embodiment, the distributed tap terminal 408 has a four-fiber input and a twelve-fiber output as described above. The main subunit 402a of the optical fiber cable carries the four fibers connected to output ports 1-4 of the terminal output, and the optical fibers in output ports 5-12 are dropped in tether cables 418. The four optical fibers in the main subunit 402a terminate in another four-fiber connector 404 that connects to the branched terminal 440, having a four fiber terminal input 442. The branched terminal 440 includes two four-fiber terminal outputs 444-1, 444-2. Optical signals from one, two, or three of the four optical fibers in the main subunit 202a can be directed into either terminal, and the remaining optical signals of the four optical fibers are directed into the other terminal. In this way, optical fiber cables 400 can be branched off in different directions at the branched terminal 440. Further, by using four-fiber inputs 442 and outputs 444-1, 444-2, the modular nature of the structure can be maintained with only the branched terminal needing to be selected to provide for the desired number of optical signals to branch in each direction. While a four-fiber architecture was considered, the number of ports at the terminal input 442 and terminal outputs 444-1, 444-2 may be fewer or greater than that.

FIG. 15 depicts an example of a branched terminal 440 that also includes a tap 434 and a splitter 436. In this way, the branched terminal 440 not only provides branching but also allows for tethers 418 to be dropped on the optical fiber cable 400 extending from the branched terminal 440. In the embodiment shown in FIG. 15, only optical signal from one optical fiber 432-1 is branched and divided to the first terminal output 444-1 with the other three optical fibers 432-2, 434-3, 434-4 passing through and indexing to output ports 1-3 of the second terminal output 444-2. The first terminal output 444-1 includes a twelve-fiber connector for optical fibers to be (directly or indirectly through an interviewing twelve-fiber cable) connected to the optical fibers of the main subunit 402a and the auxiliary subunits 420b-h, and any additional tether cables 418. Further, while FIG. 15 depicts only one optical fiber 432-1 splitting such that eight tethers 418 can be dropped immediately downstream of the first terminal output 444-1 of the branched terminal 440, the branched terminal may contain another tap 434 and splitter 436 such that, e.g., the second optical fiber 432-2 can also be branched within the branched terminal 440. In this way, eight tethers 418 can be dropped immediately downstream of the second terminal output 444-2 of the branched terminal 440 in another direction without an intervening distributed tap terminal 408.

Advantageously, the foregoing optical fiber cables 200, 300, 400 and architectures provide modular systems capable of flexibly deploying an optical network over long distances (such as in a rural setting) using existing equipment. Further, any complexity in the system (indexing, branching, division of optical signal, etc.) can be moved from the cable to the terminals, allowing for most of the difficulties encountered during installation to be addressed in the factory during manufacturing of the system components.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more than one component or element, and is not intended to be construed as meaning only one.

It will be apparent to those skilled in the art that various modifications and variations can be made without departing from the spirit or scope of the disclosed embodiments. Since modifications, combinations, sub-combinations and variations of the disclosed embodiments incorporating the spirit and substance of the embodiments may occur to persons skilled in the art, the disclosed embodiments should be construed to include everything within the scope of the appended claims and their equivalents.

What is claimed is:

1. A fiber distribution system, comprising:
an optical fiber cable, comprising:
a cable jacket having an inner surface, an outer surface, and an opening extending through the inner surface and the outer surface, the inner surface defining a central bore extending along a longitudinal axis of the optical fiber cable and the outer surface defining an outermost surface of the optical fiber cable;
a plurality of optical fibers disposed within the central bore, the plurality of optical fibers comprising a first optical fiber that extends from the central bore through the opening of the cable jacket;
an optical splitter disposed outside of the optical fiber cable, the first optical fiber optically coupled to a first end of the optical splitter, the optical splitter configured to split the optical signal of the first optical fiber into at least two components;
at least two optical fibers optically coupled to a second end of the optical splitter, each optical fiber of the at least two optical fibers configured to carry a component of the at least two components;
an overmold surrounding the opening of the cable jacket and the optical splitter.

2. The fiber distribution system of claim 1, further comprising a tether cable comprising a tether jacket extending from a first tether end to a second tether end, the tether jacket surrounding one or more of the at least two optical fibers.

3. The fiber distribution system of claim 2, wherein the tether cable comprises a connector at the second tether end.

4. The fiber distribution system of claim 1, wherein the optical splitter comprises is a 1:2,1:4, 1:8, 1:16, or a 1:32 optical splitter.

5. The fiber distribution system of claim 1, wherein the plurality of optical fibers are arranged in one or more subunits comprising a first subunit, the first subunit having a buffer tube, and wherein the first optical fiber extends through the buffer tube into the central bore and out of the opening of the cable jacket.

6. The fiber distribution system of claim 5, wherein the one or more subunits comprises a second subunit and wherein one or more of the at least two optical fibers is spliced into an optical fiber of the second subunit.

7. The fiber distribution system of claim 1, wherein the plurality of optical fibers comprises a second optical fiber that extends from the central bore through a second opening in the cable jacket downstream of the opening;
wherein a second optical splitter is disposed outside of the optical fiber cable adjacent to the second opening, the second optical fiber is optically coupled to the second optical splitter;
wherein the fiber distribution system comprises at least two additional optical fibers optically coupled to the second optical splitter; and
wherein a second overmold surrounds the second opening of the cable jacket and the second optical splitter.

8. The fiber distribution system of claim 1, wherein the optical fiber cable comprises a main subunit and a plurality of auxiliary subunits;
wherein the main subunit comprises the cable jacket and the plurality of optical fibers;
wherein each auxiliary subunit of the plurality of auxiliary subunits comprises an auxiliary optical fiber;
wherein each auxiliary optical fiber of each auxiliary subunit is coupled to the second end of the optical splitter such that the at least two optical fibers are the auxiliary optical fibers of the plurality of auxiliary subunits; and
wherein the plurality of auxiliary subunits drop from main subunit at respective points along a length of the main subunit.

9. The fiber distribution system of claim 8, wherein the plurality of optical fibers of the main subunit is optically coupled in a sequential order to a first connector at a first end of the main subunit upstream of the overmold, wherein the plurality of optical fibers except for the first optical fiber define a remainder of the optical fibers, and wherein the remainder of the optical fibers are coupled in a shifted sequential order to a second connector such that each optical fiber of the remainder of the optical fibers is shifted one position.

10. A fiber distribution system, comprising:
an optical fiber cable, comprising:
a main subunit comprising a plurality of optical fibers, the plurality of optical fibers extending through an opening in the main subunit;
a plurality of auxiliary subunits stranded together with the main subunit along a longitudinal axis of the optical fiber cable, each auxiliary subunit containing an auxiliary optical fiber having an upstream side and a downstream side;
an overmold surrounding the opening of the main subunit;
wherein a first half of the plurality of optical fibers are optically coupled to the upstream sides of the auxiliary optical fibers and a second half of the plurality of optical fibers are coupled to the downstream sides of the auxiliary optical fibers;
wherein each auxiliary subunit drops off from the main subunit at a location upstream of the overmold and at a location downstream of the overmold.

11. The fiber distribution system of claim 10, wherein the main subunit further comprises a first optical fiber in addition to the plurality of optical fibers, wherein the optical fiber cable further comprises a tether cable, the tether cable comprising a tether optical fiber, wherein the first optical fiber is optically coupled to the tether optical fiber, and wherein the overmold further surrounds at least a portion of the tether cable.

12. The fiber distribution system of claim 10, wherein the plurality of optical fibers comprises at least twelve optical fibers and wherein the plurality of auxiliary subunits comprises five auxiliary subunits.

13. The fiber distribution system of claim 12, further comprising a first tether cable that comprises a first tether optical fiber and a second tether cable that comprises a second tether optical fiber, wherein the main subunit comprises a first optical fiber and a second optical fiber in addition to the plurality of optical fibers, wherein the first optical fiber is optically coupled to the first tether optical fiber and the second optical fiber is optically coupled to the second tether optical fiber, and wherein the overmold further surrounds at least a portion of the first tether cable and the second tether cable.

14. The fiber distribution system of claim 10, wherein each auxiliary subunit of the plurality of auxiliary subunits comprises an upstream end and a downstream end and wherein each upstream end and each downstream end is connectorized.

15. A fiber distribution system, comprising:
a first distributed tap terminal comprising a terminal input with a first number of terminal input ports and a terminal output with a second number of terminal output ports, the second number being greater than the first number, the first distributed tap terminal configured to divide optical signals from the terminal input ports of the terminal input among the terminal output ports of the terminal output, the first number of terminal input ports comprising a first optical input port, the second number of terminal output ports comprising a first output port and a plurality of other output ports;
a first optical fiber cable optically coupled to the terminal output, the first optical fiber cable comprising:
a main subunit having a first end and a second end, the main subunit comprising at least one optical fiber coupled to the first output port at the first end of the main subunit; and
a plurality of auxiliary subunits, each auxiliary subunit of the plurality of auxiliary subunits comprising an auxiliary optical fiber, each auxiliary optical fiber coupled to an other output port of the plurality of other output ports; and
a first connector optically coupled to the second end of the main subunit, the first connector configured to make a third number of optical connections, the third number being equal to the first number;
wherein the plurality of auxiliary subunits drop from main subunit at respective points along a length of the main subunit between the first end and the second end.

16. The fiber distribution system of claim 15, wherein the distributed tap terminal further comprises:
a tap comprising a tap input, a first tap output, and a second tap output, the tap input optically coupled to the first optical input port, the tap configured to divide an optical signal into a first component and a second component, the first component carried on the first tap output and the second component carried on the second tap output, the first tap output being optically coupled to the first output port; and
a splitter comprising a splitter input and a plurality of splitter outputs, the splitter input being optically coupled to the second tap output, the plurality of splitter outputs being optically coupled to the plurality of other output ports, the splitter configured to divide the second component evenly among the plurality of other optical output ports.

17. The fiber distribution system of claim 16, wherein the tap is a 90/10 tap, an 80/20 tap, a 70/30 tap, or a 60/40 tap.

18. The fiber distribution system of claim 15, wherein the at least one optical fiber of the main subunit comprises a plurality of optical fibers;
wherein the connector of the main subunit is coupled to a branched terminal having a first branched terminal input, a first branched terminal output, and a second branched terminal output;
wherein the branched terminal is configured to direct a first optical signal from a first optical fiber of the plurality of optical fibers at the first branched terminal input to the first branched terminal output and a second optical signal from a second optical fiber of the plurality of optical fibers at the first branched terminal input to the second branched terminal output;
wherein the first branched terminal output is optically coupled to a second optical fiber cable and the second branched terminal output is optically coupled to a third optical fiber cable.

19. The fiber distribution system of claim 18, wherein the second optical fiber cable and the third optical fiber cable have a same construction as the first optical fiber cable such that optical fiber cables within the fiber distribution system are modular.

20. The fiber distribution system of claim 18, wherein disposed between the first branched terminal input and the first branched terminal output are a tap and a splitter, the tap and the splitter configured to divide the first optical signal at the first branched terminal input into a plurality of optical signals at the first branched terminal output.
